(19) United States
(12) Patent Application Publication
(10) Pub. No.: US 2005/0208223 A1
(43) Pub. Date: Sep. 22, 2005

(54) System for preventing gas currents from impacting a coating process for a multi-layer slide coating apparatus

(75) Inventors: Roger Yonkoski, Fairport, NY (US); Ralph P. Schultz, Pittsford, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/804,939

(22) Filed: Mar. 19, 2004

(51) Int. Cl. B05C 3/02; B05D 1/30

(52) U.S. Cl. 427/356; 118/411; 118/419; 427/402; 427/420

(57) ABSTRACT

A system prevents gas currents from impacting a coating process for a multi-slot slide bead coating apparatus. The system includes a multi-layer slide coating apparatus for forming a multilayer composite including a carrier layer and a slide surface; and a web for coating by the multi-slot slide bead coating apparatus. Additionally, a proximity shield is placed in close proximity to both the web and the slide surface of the multi-slot slide bead coating apparatus such that gas currents do not disturb the multilayer composite on the slide surface.

### FIELD OF THE INVENTION

The invention relates generally to the field of coating a moving web, and in particular to slide bead coating. More specifically, the invention relates to a proximity shield to prevent gas currents from disturbing the coating layers as they are applied using slide bead coating.

### BACKGROUND OF THE INVENTION

Bead coating is well known in the prior art as described, for example, in U.S. Pat. No. 2,761,791. One of ordinary skill in the art uses bead coating to apply multiple layers of liquid to a moving web. In the method typically referred to as slide bead coating, a multilayer composite comprised of superimposed individual coating layers is delivered to the moving web through the use of a coating die. At the end of the coating die, the layers form a continuous liquid bridge or coating bead between the die and the moving web. The slide bead coating method is useful for making thin, highly uniform, composite elements suitable for numerous applications including photographic, thermographic, x-ray, and photoelectric films, among others.

U.S. Pat. No. 6,579,569 teaches the use of a carrier slide coating method where the viscosity of the lowermost layer or carrier layer is less than 1 cp and the wet thickness of the carrier layer is less than 5 microns. The carrier layer is comprised of a single organic solvent or a blend of organic solvents. Additional coating layers with higher viscosity are applied to the web on top of the carrier layer. This method allows for application of the coatings at high web speeds and with reduced coating artifacts caused by contamination of the slide surface.

Previous attempts to eliminate the disturbance of flow of photographic coating compositions caused by impact of gas surrounding a slide coating apparatus have not been entirely successful. In some coating rooms, peak gas velocities of 200 feet per minute have been measured. The protective enclosures described in U.S. Pat. No. 4,287,240 have been found to reduce gas flow around the coating station. The enclosures are formed of a foraminous material and are effective in deflecting, diffusing and decelerating ambient forced gas currents. Such forced gas currents are frequently generated by the ventilating and exhausting equipment in the vicinity of the coating apparatus, or by the opening and closing of doors to the coating room, or by movement of personnel in the vicinity of the coating apparatus. The foraminous enclosure is designed to enclose the entire slide coating apparatus and the coating zone, and is not closely spaced to the slide surface of the coating apparatus. Indeed, in U.S. Pat. No. 4,287,240 it is stated that the enclosure should be spaced in the range of about 5 to about 60 cm from the coating composition. Optimum results have been achieved with enclosures formed of a plurality of spaced wall members, each of which is composed of a foraminous material. The best enclosures reduce peak velocities of gas flow to approximately 13 cm/sec. However, even such velocities have been shown to cause disturbances in the coating compositions on the slide which often appear as broad longitudinal streaks in the resulting coating. In most products these streaks are objectionable.

WO Patent No. 90/01178 describes the use of a close proximity shield to protect liquid flowing down the inclined slide surface from adverse effects of convection gas currents. The temperature of the proximity shield was described to be kept at the same temperature as the coating fluid to prevent condensation of evaporated water. The proximity shield was required to be uniformly spaced 6 to 10 mm from the liquid surface. The proximity shield was described to extend over substantially all the inclined slide surfaces of the coating apparatus. The precise position of the end of the shield was not specified, however it was described to be far enough from the coating backing roller that it allows the coating bead to be viewed by the operators. At least 13 mm spacing would be required for the operator to view the coating bead. The convection gas flow between the solid surface of the coating apparatus and the shield was minimized by closing the space between the shield and the backland area above the uppermost metering slot. Although this shield may work well for the coating composition and thickness described therein, the shield-to-web gap described, therein, is not adequate for carrier slide composition as described in U.S. Pat. No. 6,579,569. Unwanted bands of non-uniform density, or longitudinal streaks, occur when the proximity shield is spaced far enough from the coating backing roller for the operator to view the coating bead.

### PROBLEM TO BE SOLVED BY THE INVENTION

Longitudinal streaks appear as a result of slide bead coating a coating composition that includes higher viscosity layers and a bottom most layer having a viscosity of less than 1 cp. Accordingly, elimination of these streaks and bands is paramount for a high quality coating process.

### SUMMARY OF THE INVENTION

The present invention is directed to overcoming one or more of the problems set forth above. One aspect of the present invention provides a system for preventing gas currents from impacting a coating process for a multi-layer slide coating apparatus, the system includes a multi-layer slide coating apparatus for forming a multilayer composite including a carrier layer and an inclined slide surface; and a web for coating by the multi-layer slide coating apparatus. Additionally, a proximity shield is placed in close proximity to both the web and the inclined slide surface of the multi-layer slide coating apparatus such that gas currents do not disturb the multilayer composite on the inclined slide surface.

### BRIEF DESCRIPTION OF THE DRAWINGS

The above and other features and advantages of the present invention will become more apparent when taken in conjunction with the following description and drawings wherein identical reference numerals have been used, where possible, to designate identical features that are common to the figures, and wherein:

FIG. 1 is a schematic of an exemplary multi-slot slide bead coating apparatus including a proximity shield which may be used in the practice of the method of the present invention;

FIG. 2 shows the proximity shield in profile;

FIG. 3 is a close-up drawing of different embodiments of the shield lip area; and

FIG. 4 is a drawing of the edge of the shield and how it integrates with the edge guide.

### DETAILED DESCRIPTION OF THE INVENTION

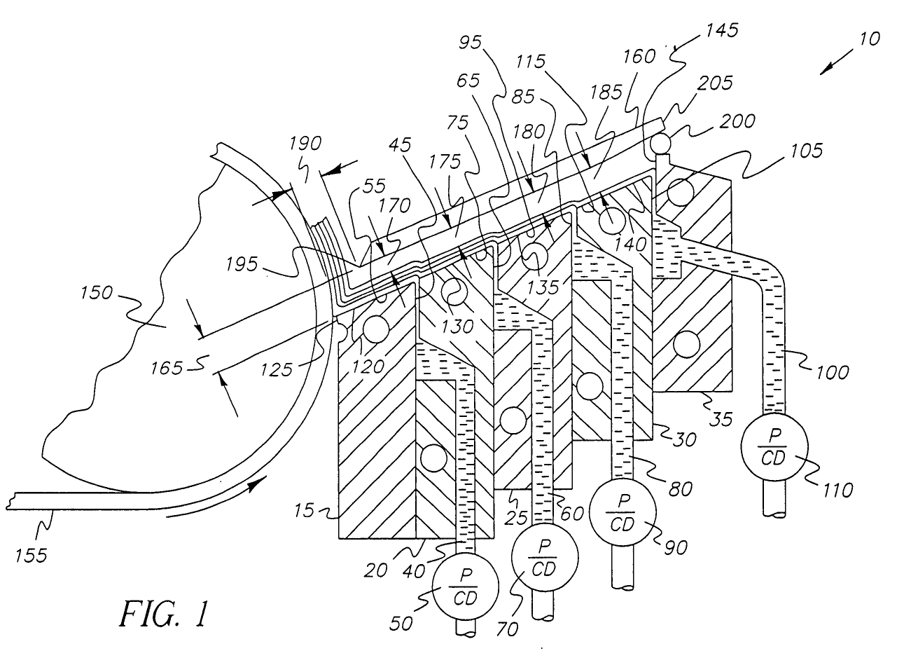

Referring to FIG. 1, a schematic shows an exemplary multi-slot slidebead coating apparatus 10 suitable for practicing the method of the present invention. The multi-slot slide bead coating apparatus 10 is typically used to deliver and coat multiple coating compositions simultaneously as a stacked composite of layers. Multi-slot slide bead coating apparatus 10 is shown as having only four slots but multiple slot coating apparatuses may have fewer than four slots and are also known to deliver a composite layer comprised of five or six (or even more) coating composition layers.

Multi-slot slide bead coating apparatus 10, shown in a side elevation cross-section in FIG. 1, includes a front section 15, a second section 20, a third section 25, a fourth section 30, and a back plate 35. There is an inlet 40 into second section 20 for supplying coating liquid to first metering slot 45 via pump 50 to thereby form a lowermost layer or carrier layer 55. There is an inlet 60 into third section 25 for supplying coating liquid to second metering slot 65 via pump 70 to form layer 75. There is an inlet 80 into fourth section 30 for supplying coating liquid to third metering slot 85 via pump 90 to form layer 95. There is an inlet 100 into back plate 35 for supplying coating liquid to fourth metering slot 105 via pump 110 to form layer 115. Each metering slot 45, 65, 85, and 105 includes a transverse distribution cavity. Front section 15 includes a first inclined slide surface 120, and a coating lip 125. There is a second inclined slide surface 130 at the top of second section 20. There is a third inclined slide surface 135 at the top of third section 25. There is a fourth inclined slide surface 140 at the top of fourth section 30. Back plate 35 extends above the fourth inclined slide surface 140 to form a back land surface 145.

Residing adjacent to the multi-slot slide bead coating apparatus 10 is a coating backing roller 150 about which a web 155 is conveyed. Typically, the multi-slot slide bead coating apparatus 10 is movable from a non-coating position toward the coating backing roller 150 and into a coating position.

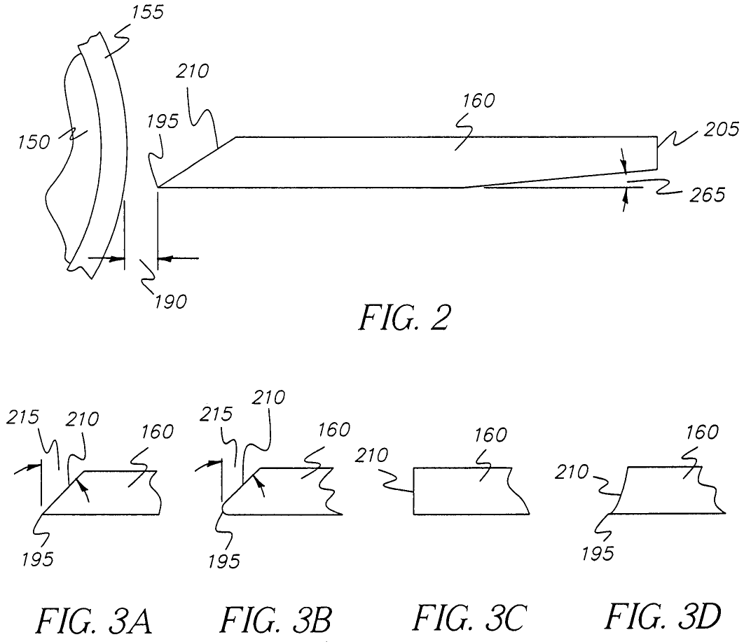

Still referring to FIG. 1, the method of the present invention has a proximity shield 160 (also shown in greater detail in FIG. 2) placed a certain distance from the first inclined slide surface 120, forming a shield-to-slide surface gap 165 between the proximity shield 160 and the first inclined slide surface 120. The shield-to-slide surface gap 165 is defined as the closest distance between the proximity shield 160 and the first inclined slide surface 120. The proximity shield is positioned to be substantially parallel to the first inclined slide surface 120. The proximity shield 160 is also placed or designed in such a manner that there are shield-to-liquid gaps 170, 175, 180, and 185 between the proximity shield 160 and the liquid layer 115. The proximity shield 160 is positioned so that there is a specific shield-to-web gap 190 between the shield lip 195 and the web 155. A seal 200 is made between the shield back 205 and the back land surface 145. The shield-to-slide surface gap 165 can range from 4 mm to 13 mm. The more preferred range is 5 mm to 8 mm, with the most preferred value equal to 6 mm.

FIGS. 2 & 3 show the proximity shield in more detail. FIG. 2 shows a shield lip 195 and a front face 210. Different embodiments of the shield lip 195 and front face 210 are shown in FIG. 3. The shield lip 195 can be a sharp point as shown in configuration 3A. The shield lip 195 can also be rounded as shown in configuration 3B. The radius of curvature of the shield lip 195 can range from 1 micron to 10 mm. In the extreme, the radius can be infinite corresponding to the flat surface shown in configuration 3C. In this embodiment, there is no shield lip 195, only a front face 210. In configurations 3A and 3B, the front face 210 is cut away forming an angle 215 so that the shield lip 195 is the closest point to the moving web 155. This angle 215 can be between 10 and 80 degrees. For the exemplary embodiment shown in FIG. 2, the angle is 56 degrees. The shield-to-web gap 190 is defined as the closest distance between the proximity shield 160 and the web 155. For configurations 3A and 3B the closest point of the proximity shield 160 would typically be the shield lip 195. For configuration 3C, this would depend on location of the coating lip 125 in relation to the coating backing roller 150, as well as the angle of the first inclined slide surface 120.

Configuration 3D is an alternative embodiment where the front face 210 is curved to match the curvature of the coating backing roller 150. In this case the entire front face 210 is substantially the same distance from the web 155. There is no shield lip 195 to define for configuration 3D.

FIG. 2 demonstrates a step cutback angle 265. For example, the proximity shield 160 may be angularly cut from 0-65°. This portion of the proximity shield 160 is cut back in order to maintain the shield-to-liquid gaps 175, 180, and 185. If the combination of total coating layer thickness and any difference in height between the inclined slide surfaces 120, 130, 135, 140 (not shown in FIG. 1) would cause the coating liquid to close the shield-to-liquid gaps 175, 180, 185, then the proximity shield 160 can be cut back to avoid this. For some fluid and coating apparatuses, it may not be necessary to have a step cutback angle 265.

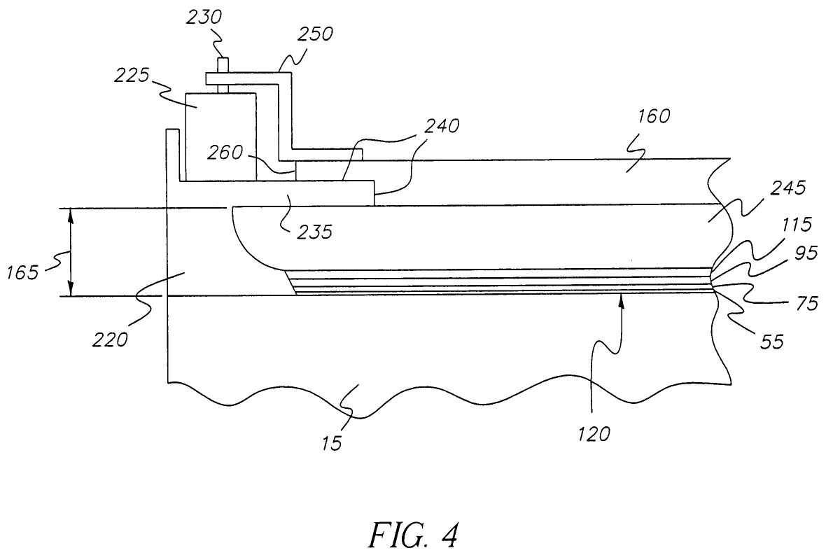

FIG. 4 shows a nexus between the proximity shield 160 and an edge guide 220. The edge guide 220 contains the fluid on the inclined slide surfaces 120, 130, 135, and 140 (shown in FIG. 1) and defines the coating width (not shown). An edge guide holder 225 is used to hold the edge guide 220 to the inclined slide surfaces 120, 130, 135, and 140. A pin 230 is attached to the edge guide holder 225. The edge guide 220 has an overhang portion 235 which extends over the coating layer 115. The proximity shield 160 has a cut out area 240 which mates with the overhang portion 235 of the edge guide 220. This mating forms an effective seal to prevent gas from leaking into or out of a gas space 245 located under the proximity shield 160. The proximity shield 160 also has a bracket 250, which has a hole (not shown) that fits over the pin 230. The connection between the bracket 250 and the proximity shield 160 is adjustable so that the pin 230 maintains the desired shield-to-web gap 190.

The gas contained within the gas space 245 may be air. It may also be an inert gas such as Nitrogen or Carbon Dioxide. The inert gas could also have added solvent vapors to retard drying of the coating fluids on the edge guide 220 or the back land surface 145.

In addition to the embodiment shown in FIG. 4, alternate arrangements for positioning the shield are possible. The pin 230 could be replaced with a notch or hook or screw. Instead of a pin 230, the edge guide 220 could have a ledge on which the bracket 250 rests. Other arrangements are envisions that set both the shield-to-slide surface gap 165 and the shield-to-web gap 190. The proximity shield 160 could also not include a cut out area 240, in which case the proximity shield 160 would sit directly on top of the overhang portion 235.

In one embodiment of the present invention, the lowermost or carrier layer 55 (shown in FIG. 1) is an organic solvent or blend of organic solvents that is substantially free of other constituents. The term “substantially free of other constituents” as used herein is intended to mean that the organic solvent or blend of organic solvents have a purity level of at least about 98% and that any contaminants or additives present do not affect the viscosity of the carrier layer 55. Examples of suitable organic solvents include methanol, acetone, methylethyl ketone, methyl isobutyl ketone, methylene chloride, toluene, methyl acetate, ethyl acetate, isopropyl acetate, and n-propyl acetate. In another embodiment, the carrier layer 55 may also be a diluted version of the upper liquid layer 75. The carrier layer 55 may also contain other addendum such as polymers or dyes as long as they do not significantly affect the viscosity of the carrier layer 55.

The second liquid layer 75 which is metered through a second metering slot 65, moves down the second inclined slide surface 130, and is accelerated by the carrier layer 55 down the first inclined slide surface 120 to the coating bead 255. The second liquid layer 75 should preferably be totally miscible with lowermost layer 55 and is therefore preferably organic, but may also contain water. As layers 95 and 115 in FIG. 1 are shown, additional upper layers may also be applied using the multi-slot slide bead coating apparatus 10. These additional upper layers may be of a distinct composition relative to the second liquid layer 75 or of the same composition. Similarly, the number of upper layers may also be further increased by extension of the number of metering slots (not explicitly shown in FIG. 1).

Because the method of the present invention may involve application of highly volatile organic solvents, the temperature at which coating is performed is preferably less than or equal to 25° C. to avoid non-uniformities due to streaks and mottle. Methylene chloride, acetone, methyl acetate and methanol are examples of highly volatile organic solvents having a vapor pressure above 100 mm Hg at 25° C. The proximity shield 160 is typically maintained at the same temperature as coating fluids in order to avoid thermal gradients within the gas space 245.

The carrier slide coating method, as described in U.S. Pat. No. 6,579,569, is extremely sensitive to stray gas currents as well as gas currents induced by the coating method itself. This is especially true when the coating layers are very thin (<5 microns for the carrier layer 55 and <10 microns for the sum of the subsequent layers 75, 95, and 115). Conventional slide coating typically uses layers that are much greater in thickness. This sensitive nature of the coating layers results in very precise requirements for the placement of a proximity shield 160. Conventional methods teach that the shield-to-web gap 190 can be large enough that an operator can view the coating bead 255. For carrier slide coating with coating construction described herein, if the shield-to-web gap 190 were allowed to be this large, the subsequent coating quality would be very poor. This is because the coating bead 255 would be disturbed by gas currents and longitudinal streaks would occur.

When the coating solutions contain volatile organic solvents, the drying at the static contact lines can be substantial. In order to prevent this drying, a clam shell must be created wherein the shield edges 260 and the shield back 205 are sealed. This clamshell can be either passive or solvent laden gas can be supplied. If the proximity shield 160 is sealed at the shield edges 260 outside the edge guides 220, there will be a greater region of atmosphere requiring saturation as well as the risk of stray gas currents occurring at the edges. In order to prevent these problems, the proximity shield 160 is integrated with the edge guide 220 as shown in the FIG. 4. This integration effectively creates the enclosure. Referring to FIG. 4, the overhang portion 235 of the edge guide 220 serves as a means for creating a seal, as a means for holding the proximity shield 160 in place; as a means for setting the shield-to-slide surface gap 165, as a means for maintaining a parallelism between the proximity shield 160 and the first inclined slide surface 120; and as a means for creating a partially saturated environment at the edges when the proximity shield 160 is not yet in place.

The proximity shield 160 can be sealed in the back in a number of ways. A gasket material, such as rubber, can be used to create a seal 200. Alternatively, the proximity shield 160 can rest on the back land surface 145 of the multi-slot slide bead coating apparatus 10. The proximity shield 160 can either be placed directly on the edge guides 220 and seal 200 or else a movable and/or hinged design could be envisioned. Another embodiment is to have no back seal 200 where there is an opening between the shield back 205 and the back land surface 145.

When the proximity shield 160 is completely sealed, the only place for gas exchange between the outside and the gas space 245 under the proximity shield 160 is through the shield-to-web gap 190. The placement of the proximity shield 160 relative to the web 155, i.e. the shield-to-web gap 190, was found to be instrumental to forming a coating without objectionable defects, such as longitudinal streaks.

The proximity shield 160 can be constructed from a variety of materials, such as plastic, glass, metal, metal alloys, wood, or paper. The proximity shield 160 can also be made from a combination of these materials. Example plastic materials are polyethylene, Teflon, and polycarbonate. The proximity shield 160 can be made from a transparent material in order to enable the operator to see the fluid underneath. A transparent plastic material, such as polycarbonate, could be coated with a protective layer. Some of the purposes for this protective layer are to provide static dissipation properties and to protect the material from attack by the organic solvents. Hence, a semi-transparent metal may coat the transparent plastic.

### COMPARATIVE EXAMPLE 1

The multi-slot slide bead coating apparatus 10 illustrated in FIG. 1 was used to apply two organic layers to a moving web 155 of untreated polyethylene terephthalate (PET). The carrier layer 55 consisted of a mixture of solvents, having a viscosity of 0.9 cp and a wet thickness of 3.23 μm on the web 155. The second layer was a mixture of polymer, dye and organic solvents. The second layer was delivered through the second, third and fourth metering slots 65, 85, 105, respectively, and had a viscosity of 750 cp and a combined final wet thickness of 3.49 μm on the web 155. Coatings were applied at a temperature of 23.9° C. The gap between the coating lip 125 and the moving web 155 was 200 μm. The pressure differential across the coating bead 255 was 1.8 cm H₂O. The web speed was 190 m/min.

When the proximity shield 160 was used, the shield-to-slide surface gap 165 was set to 6 mm and the shield-to-web gap 190 was set to 3.18 mm. Table A demonstrates the effectiveness of the proximity shield 160 for preventing density bands (or longitudinal streaks).

TABLE A

| Proximity Shield 160 | Resulting Coating Quality |
|---|---|
| Off | Severe wide variable bands |
| On | No bands or streaks |

### COMPARATIVE EXAMPLE 2

The same coating compositions were used as described in comparative example 1. In this case the shield-to-web gap 190 was varied according to Table B. There is an optimum value for the shield-to-web gap 190. When the distance is too small, short narrow wavy bands occur. When the distance is too large, severe bands occur similar to that seen when there is no proximity shield 160 in place. The shield-to-web gap 190 that would allow the operator to see the coating bead 255 is the last value in Table B, 13 mm. At this distance, the bands are severe. The available range for shield-to-web gap 190 is between 2.5 and 4.5 mm. The most preferred shield-to-web gap 190 is 3.18 mm.

TABLE B

| Shield-to-Web Gap 90 (mm) | Resulting Coating Quality |
|---|---|
| 1.27 | Short narrow wavy bands |
| 1.91 | Narrow bands or streaks |
| 2.54 | Narrow streaks that move |
| 3.18 | No bands or streaks |
| 4.45 | Wide variable bands |
| 6.35 | Severe wide variable bands |
| 13.0 | Severe wide variable bands |

The invention has been described with reference to one or more embodiments. However, it will be appreciated that a person of ordinary skill in the art can effect variations and modifications without departing from the scope of the invention.

### PARTS LIST

10 Multi-slot slide bead coating apparatus
15 Front section
20 Second section
25 Third section
30 Fourth section
35 Back plate
40 Inlet
45 First metering slot
50 Pump
55 Carrier layer
60 Inlet
65 Second metering slot
70 Pump
75 Layer
80 Inlet
85 Third metering slot
90 Pump
95 Layer
100 Inlet
105 Fourth metering slot
110 Pump
115 Layer
120 First inclined slide surface
125 Coating lip
130 Second inclined slide surface
135 Third inclined slide surface
140 Fourth inclined slide surface
145 Back land surface
150 Coating backing roller
155 web
160 Proximity shield
165 Shield-to-slide surface gap
170 Shield-to-liquid gap
175 Shield-to-liquid gap
180 Shield-to-liquid gap
185 Shield-to-liquid gap
190 Shield-to-web gap
195 Shield lip
200 Seal
205 Shield back
210 front face
215 Angle
220 Edge guide
225 Edge guide holder
230 Pin
235 Overhang portion
240 Cut out area
245 Gas space
250 Bracket
255 Coating bead
260 Shield edge
265 Step cutback angle

1. A system for preventing gas currents from impacting a coating process for a multi-slot slide bead coating apparatus, comprising:
a) a multi-slot slide bead coating apparatus for forming a multilayer composite including a carrier layer having a viscosity <1 cP and a wet thickness <5 microns and a slide surface;
b) a web for coating by the multi-slot slide bead coating apparatus; and
c) a nonforaminous proximity shield positioned substantially parallel to the slide surface while being in close proximity to both the web and the slide surface of the multi-slot slide bead coating apparatus such that gas currents do not disturb the multilayer composite on the slide surface.

2. The system claimed in claim 1, wherein the proximity shield is placed within 2.5-4.5 mm of the web to form a shield-to-web gap.

3. The system claimed in claim 1, wherein the proximity shield is placed within 3.18 mm of the web.

4. The system claimed in claim 1, wherein the carrier layer has a viscosity <1 cp and a wet thickness <5 microns.

5. The system claimed in claim 1, wherein the carrier layer has a viscosity between 0.7 and 1.0 cp and a wet thickness about 3 microns.

6. The system claimed in claim 1, wherein the proximity shield placed near the slide surface forms a shield-to-slide surface gap, having a height measurement range of 4-13 mm.

7. The system claimed in claim 1, wherein the proximity shield placed near the slide surface forms a shield-to-slide surface gap, having a height measurement of 6 mm.

8. The system claimed in claim 1, wherein the proximity shield is prevented from contacting a coating liquid on the slide surface of the multi-slot slide bead coating apparatus.

9. The system claimed in claim 8, wherein the proximity shield is angularly cut to form a step cutback angle of 0-65°.

10. The system claimed in claim 1, wherein the proximity shield includes a shield lip having a curvature range of 1 micron to 10 mm.

11. The system claimed in claim 1, wherein the proximity shield includes a front face curved to match a corresponding curvature of a coating backing roller in the multi-slot slide bead coating apparatus.

12. The system claimed in claim 1, further comprising:
d) an edge guide for creating a seal by mating with the proximity shield, wherein the edge guide has an overhang portion which extends over a coating layer.

13. The system claimed in claim 1, wherein the proximity shield is constructed of materials selected from the group consisting of plastic, glass, metal, metal alloys, wood and paper.

14. The system claimed in claim 13, wherein the proximity shield is constructed of a transparent plastic and coated with a semi-transparent metal.

15. The system claimed in claim 12, wherein an edge guide holder holds the edge guide to the slide surface.

16. The system claimed in claim 15, wherein the edge guide holder includes means for holding the proximity shield in place to form a shield-to-web gap.

17. A system for preventing gas currents from impacting a coating process for a multi-slot slide bead coating apparatus, comprising:
a) a multi-slot slide bead coating apparatus for forming a multilayer composite including a carrier layer and an inclined slide surface; wherein the carrier layer has a viscosity <1 cp and a wet thickness <5 microns, and is the lowermost layer of the multilayer composite;
b) a web for coating by the multi-slot slide bead coating apparatus; and
c) means for placing a nonforaminous proximity shield substantially parallel to the inclined slide surface while being in close proximity to both the web and the inclined slide surface of the multi-slot slide bead coating apparatus such that gas currents do not disturb the multilayer composite on the inclined slide surface.

18. The system claimed in claim 17, wherein the proximity shield is placed within 2.5-4.5 mm of the web to form a shield-to-web gap.

19. The system claimed in claim 17, wherein the proximity shield is placed within 3.18 mm of the web.

20. The system claimed in claim 17, wherein the carrier layer has a viscosity <1 cp and a wet thickness <5 microns.

21. The system claimed in claim 17, wherein the carrier layer has a viscosity between 0.7 and 1.0 cp and a wet thickness about 3 microns.

22. The system claimed in claim 17, wherein the proximity shield placed near the slide surface forms a shield-to-slide surface gap, having a height measurement range of 4-13 mm.

23. The system claimed in claim 17, wherein the proximity shield is prevented from contacting a coating liquid on the slide surface of the multi-slot slide bead coating apparatus.

24. The system claimed in claim 23, wherein the proximity shield is angularly cut to form a step cutback angle of 0-65°.

25. The system claimed in claim 17, wherein the proximity shield includes a shield lip having a curvature range of 1 micron to 10 mm.

26. The system claimed in claim 17, wherein the proximity shield includes a front face curved to match a corresponding curvature of a coating backing roller in the multi-slot slide bead coating apparatus.

27. The system claimed in claim 17, further comprising:
d) an edge guide for creating a seal by mating with the proximity shield, wherein the edge guide has an overhang portion which extends over a coating layer.

28. The system claimed in claim 17, wherein the proximity shield is constructed of materials selected from the group consisting of plastic, glass, metal, metal alloys, wood and paper.

29. The system claimed in claim 28, wherein the proximity shield is constructed of a transparent plastic and coated with a semi-transparent metal.

30. A method for preventing gas currents from impacting a coating process for a multi-slot slide bead coating apparatus, comprising the steps of:
a) providing a multi-slot slide bead coating apparatus for forming a multilayer composite including a carrier layer having a viscosity <1 cp and a wet thickness <5 microns, and a slide surface;
b) providing a web for coating by the multi-slot slide bead coating apparatus;
c) positioning a nonforaminous proximity shield substantially parallel to the slide surface while being in close proximity to both the web and the slide surface of the multi-slot slide bead coating apparatus such that gas currents do not disturb the multilayer composite on the slide surface.

31. The method claimed in claim 30, wherein the proximity shield is placed within 2.5-4.5 mm of the web to form a shield-to-web gap.

32. The method claimed in claim 30, wherein the proximity shield is placed within 3.18 mm of the web.

33. The method claimed in claim 30, wherein the carrier layer has a viscosity <1 cp and a wet thickness <5 microns.

34. The method claimed in claim 30, wherein the carrier layer has a viscosity between 0.7 and 1.0 cp and a wet thickness about 3 microns.

35. The method claimed in claim 30, wherein the proximity shield placed near the slide surface forms a shield-to-slide surface gap, having a height measurement range of 4-13 mm.

36. The method claimed in claim 1, wherein the proximity shield is prevented from contacting a coating liquid on the slide surface of the multi-slot slide bead coating apparatus.

37. The method claimed in claim 36, wherein the proximity shield is angularly cut to form a step cutback angle of 0-65°.

38. The method claimed in claim 30, wherein the proximity shield includes a shield lip having a curvature range of 1 micron to 10 mm.

39. The method claimed in claim 30, wherein the proximity shield includes a front face curved to match a corresponding curvature of a coating backing roller in the multi-slot slide bead coating apparatus.

40. The method claimed in claim 30, further comprising:
d) an edge guide for creating a seal by mating with the proximity shield, wherein the edge guide has an overhang portion which extends over a coating layer.

41. The method claimed in claim 30, wherein the proximity shield is constructed of materials selected from the group consisting of plastic, glass, metal, metal alloys, wood and paper.

42. The method claimed in claim 41, wherein the proximity shield is constructed of a transparent plastic and coated with a semi-transparent metal.

43. The method claimed in claim 40, wherein an edge guide holder holds the edge guide to the slide surface.

44. The method claimed in claim 43, wherein the edge guide holder includes means for holding the proximity shield in place to form a shield-to-web gap.

45. A method for preventing gas currents from impacting a coating process for a multi-slot slide bead coating apparatus, comprising the steps of:
a) providing a multi-slot slide bead coating apparatus for forming a multilayer composite including a carrier layer having a viscosity between 0.7 and 1.0 cp and a wet thickness about 3 microns and an inclined slide surface; wherein the carrier layer is the lowermost layer of the multiplayer composite;
b) providing a web for coating by the multi-slot slide bead coating apparatus; and
c) means for positioning a nonforaminous proximity shield substantially parallel to the inclined slide surface while being in close proximity to both the web and the inclined slide surface of the multi-slot slide bead coating apparatus such that gas currents do not disturb the multilayer composite on the inclined slide surface.
